(19) United States
(12) Patent Application Publication
(10) Pub. No.: US 2005/0071206 A1
(43) Pub. Date: Mar. 31, 2005

(54) System, method and computer program product for schedule recovery

(75) Inventor: Matthew E. Berge, Woodinville, WA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: The Boeing Company, Chicago, IL (US)

(21) Appl. No.: 10/836,714

(22) Filed: Apr. 30, 2004

Related U.S. Application Data
(60) Provisional application No. 60/466,915, filed on Apr. 30, 2003.

(51) Int. Cl. G06F 17/60

(52) U.S. Cl. 705/6

(57) ABSTRACT

A system, method and computer program product are provided to permit the efficient recovery from schedule disruptions, such as due to a weather condition, a system outage or the like. The system, method and computer program product evaluate a plurality of leg replicants for at least some flight legs of a plurality of itineraries. The leg replicants may include flight legs that have been subject to a ground delay, cancellation or rerouting. A Lagrangian relaxation technique followed by a Lagrangian heuristic may be used to construct schedules for the itineraries from the leg replicants. During Lagrangian relaxation, some or all of the capacity constraints are relaxed to simplify its solution. During this process, a value may be assigned to each leg replicant that is at least partially based upon an objective function relating value to arrival delay. Flight legs may be swapped between itineraries to improve the resulting schedules.

### CROSS-REFERENCE TO RELATED APPLICATIONS

This application claims the benefit of U.S. Provisional Patent Application No. 60/466,915 filed Apr. 30, 2003, which is hereby incorporated herein in its entirety by reference.

### FIELD OF THE INVENTION

The present invention relates generally to methods, systems and computer program products for collaborative flow management and, more particularly, to methods, systems and computer program products for schedule recovery, such as airline schedule recovery in the event of adverse weather conditions, system outages or the like.

### BACKGROUND OF THE INVENTION

Commercial airline flights are generally scheduled well in advance. With respect to a particular aircraft, a series of flights that comprise the itinerary of the aircraft is also generally established in advance. For example, the itinerary of an aircraft may consist of a first flight from Point A to Point B, a second flight from Point B to Point C following some period of time on the ground at Point B, and finally a third flight from Point C to Point A following some period of time on the ground at Point C. This itinerary is provided by way of an example, however, since an itineraries need not necessarily begin and end at the same point and may have different numbers of flight legs.

In developing the schedules, the respective capacities of the system resources utilized to support the air traffic are taken into consideration. In this regard, airports have certain capacity limitations, such as airport arrival capacity limitations and airport departure capacity limitations that limit the rate at which flights may depart from and arrive at the airport, respectively. Additionally, the space through which aircraft travel once in flight is divided into air traffic control sectors. Each air traffic control sector also has a limited capacity. In originally scheduling the flights, therefore, consideration is given to the limitations on the various resources.

Notwithstanding the schedules developed by the various airlines, conditions, such as weather events, system outages or the like, sometimes disrupt the scheduled flights and cause flights to be delayed or cancelled. Although the original schedules were developed with consideration given to the capacity of the system resources, attempts to recover from a disruption to the flight schedule, such as by quickly dispatching those flights, which have been delayed, can cause the limitations on the system resources to be exceeded if the recovery process is not properly managed. In the United States, the focus of this flow management has been primarily centered upon airport arrival capacity limitations. In contrast, this flow management in Europe has been primarily focused on the limitations imposed by air traffic control sector capacities. In either instance, however, automation tools have been developed to determine which flights should be delayed on the ground and for how long in order to avoid exceeding the capacity of the system resources. While various flow management techniques have been utilized, a “ration by schedule” concept has been applied in the United States. By way of example of a flow management technique, the ration by schedule process is generally motivated by the concept of dividing the capacity of a system resource between the various airlines in proportion to the percentage of the overall number of scheduled flights that are to be flown by the respective airline.

It is anticipated that flow management will play an increasingly significant role in air traffic management in both the United States and Europe, as well as throughout other portions of the world. In this regard, air traffic, i.e., demand, is projected to continue to increase at a pace that will exceed any enhancements in the capacity of the various system resources, i.e., supply.

Although the focus has been principally upon airport arrival capacity limitations in the United States and upon limited air traffic control sector capacities in Europe, it is becoming increasingly apparent that the limitations on the capacity of other system resources may soon become, if they have not already become, additional limiting factors upon the airline schedule recovery process. In this regard, limitations upon the capacity of the various air traffic control sectors are becoming more significant in the United States, while the limitations upon the airport arrival and departure capacities are becoming increasingly important in Europe.

Thus, it would be desirable to develop a more comprehensive airline schedule recovery process, which takes into account the forecasted limitations in the capacity of all of the various system resources. Unfortunately, the consideration of the forecasted capacities of additional system resources makes the determination of the most desirable recovery process substantially more complex.

### SUMMARY OF THE INVENTION

A system, method and computer program product is therefore provided according to one advantageous embodiment of the present invention for identifying a nearly optimal recovery schedule in order to recover from schedule disruptions, such as due to a weather condition, a system outage or the like, either real or simulated. Advantageously, the system, method and computer program product of one embodiment of the present invention evaluate a plurality of leg replicants for at least some legs of a plurality of itineraries, such as those itineraries that originally included a flight leg that remains uncommitted. To add to the robust nature of the system, method and computer program product of the present invention, the leg replicants may include flight legs that have been subject to a ground delay, cancellation or rerouting.

According to one embodiment of the present invention, a system, method and computer program product are provided for determining an alternative schedule by identifying a plurality of leg replicants for at least some legs of a plurality of itineraries and thereafter evaluating different combinations of the leg replicants for the respective legs of the plurality of itineraries in order to construct schedules for the plurality of itineraries. In evaluating the different combinations of leg replicants, at least some capacity constraints are initially relaxed. In this regard, the different combinations of leg replicants may be evaluated by utilizing Lagrangian relaxation to initially relax at least some of the capacity constraints. Following this initial portion of the evaluation, at least some of the different combinations may be reevaluated while being subject to the capacity constraints, thereby obtaining a feasible set of schedules.

To facilitate the evaluation, a value is generally assigned to each leg replicant. The value may be based upon at least one of and, most commonly, a combination of the distance of the respective leg, the seating capacity and an objective function relating value to arrival delay. During the evaluation the different combinations of leg replicants, the schedules for the plurality of itineraries can be identified to be those schedules that are comprised of combinations of leg replicants that have the largest collective value. In this regard, a schedule may be initially determined for each itinerary to be comprised of the leg replicants having the largest collective value while at least some of the capacity constraints are relaxed. The resulting schedules may be ordered based on the collective value of the leg replicants comprising the respective schedules and subsequently reevaluated in a sequential manner while taking into account the capacity constraints.

According to another embodiment of the present invention, a system, method and computer program product are provided to swap legs between itineraries. The swapping of legs between itineraries may be performed following the initial schedule recovery process that is described above. According to this embodiment, swap opportunities in which legs may be swapped between respective pairs of itineraries are identified. A swap opportunity may be identified between a respective pair of itineraries with each itinerary having a first scheduled flight leg and a second scheduled flight leg and the pair of itineraries being such that: (i) the subsequent scheduled flight leg of one itinerary has a propagated delay, (ii) the first scheduled flight legs of both itineraries have a common destination airport; and (iii) a difference between scheduled departure times of the subsequent scheduled flight legs of the pair of itineraries is no greater than a predefined time. The swap opportunities are also generally identified between pairs of itineraries scheduled to be flown by compatible aircraft. In this regard, compatible aircraft may consist of the same type of aircraft or aircraft that are operationally equivalent.

According to this embodiment, the benefit of each swap opportunity is estimated. In this regard, a value of each itinerary may be determined to be the sum of the value of each leg included in the itinerary. For each swap opportunity that is determined to be beneficial, different combinations of leg replicants for the legs that have been swapped between the respective pair of itineraries are evaluated in order to construct schedules for the respective pair of itineraries. A swap opportunity may be determined to be beneficial if the collective value of the pair of itineraries associated with the swap opportunity exceeds the collective value of the itineraries prior to any swap of legs therebetween. Following the evaluation of different combinations of leg replicants, a value for each itinerary is determined to be the sum of the value of each leg included in that itinerary. The schedules constructed for the pairs of itineraries are then accepted if the collective value of the pairs of itineraries exceeds the collective value of the itineraries prior to any swap of the legs therebetween. By permitting swapping between aircraft, such as between compatible types of aircraft, the resulting schedules can be further improved.

According to yet another embodiment of the present invention, a system, method and computer program product are provided for determining an alternative schedule by concurrently constructing a set of revised schedules while permitting swapping between aircraft, such as compatible aircraft. According to this embodiment, a network for each pool of equipment is constructed. Within the network, each node represents an airport at a predefined period of time and each arc represents a leg replicant of a respective flight leg. Additionally, the network may be constructed such that each arc arriving at a node represents a leg replicant that has an availability time prior to a departure time of each arc departing the node. Additionally, each pool of equipment includes leg replicants for the flight legs scheduled to be flown by a plurality of compatible aircraft.

According to this embodiment, a maximum value path is then determined through the network for each of the plurality of compatible aircraft. Typically, the aircraft are ordered and the maximum value path is sequentially determined for each aircraft in order. While the network is generally constructed without taking into account at least some capacity constraints and without limiting each flight leg to a single replicant, the determination of the maximum value paths through the network eliminates any arcs representative of a leg replicant that requires more of a system resource than is available. In addition, any arcs representative of a leg replicant of a flight leg having another leg replicant that has already been included in the maximum value path constructed for another aircraft is eliminated. As such, the constraints are taken into account while determining the maximum value path through the respective network. Thus, the resulting schedules established by the maximum value paths are feasible.

The system, method and computer program product of the various embodiments of the present invention permit a controlled and effective recovery from schedule disruptions, such as due to weather conditions, system outages or the like, in a manner that ensures that the various forecasted capacity constraints are not exceeded and while taking into consideration the full range of options, including delay, cancellation and rerouting.

### BRIEF DESCRIPTION OF THE DRAWINGS

Having thus described the invention in general terms, reference will now be made to the accompanying drawings, which are not necessarily drawn to scale, and wherein:

FIG. 1 is an exemplary flight plan timeline illustrating the various system resources utilized during different time slices throughout the flight;

FIG. 2 is a block diagram illustrating the interface between a system in accordance with one embodiment of the present invention and a system command center;

FIG. 3 is a graphical representation of one exemplary objective function utilized to value flight legs of an itinerary based upon arrival delay;

FIG. 4 is a flowchart illustrating the operations performed by a system, method and computer program product for performing schedule recovery according to one embodiment of the present invention;

FIG. 5 is a graphical representation of possible flight leg replicants that may be considered in replanning or rescheduling an itinerary;

FIG. 6 is a block diagram illustrating the operations performed by a system, method and computer program product for swapping legs between itineraries according to one embodiment of the present invention;

FIG. 7 is a chronological depiction of the itineraries for first and second aircraft, which exemplifies a swap opportunity;

FIG. 8 is a flowchart illustrating the operations performed by a system, method and computer program product for performing schedule recovery according to another embodiment of the present invention;

FIG. 9 is a timeline depicting the arrivals and departures at a respective airport over a period of time;

FIG. 10 is an exemplary space time network constructed in accordance with one embodiment of the system, method and computer program product of the present invention; and

FIG. 11 is a schematic representation of a system for implementing a method according to one embodiment of the present invention.

### DETAILED DESCRIPTION OF THE PREFERRED EMBODIMENT

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

A system, method and computer program product are therefore described for providing collaborative flow management and, more particularly, for managing a schedule recovery process. While the system, method and computer program product of the present invention will be described in conjunction with processes for airline schedule recovery, the system, method and computer program product may also be applicable to other collaborative flow management processes, both in conjunction with schedule recovery as well as other applications.

The system, method and computer program product of the present invention may be utilized in a simulation environment such that airline schedule recovery plans can be formulated in response to various simulated conditions that may cause flights to be delayed, cancelled or rerouted, thereby supporting system engineering efforts and the like. Alternatively, the system, method and computer program product of the present invention may be deployed as a decision support product to provide possible airline schedule recovery plans to the personnel responsible for air traffic management in the event of an actual or anticipated schedule disruption, such as on the day of the disruption.

As described below, the system, method and computer program product of the present invention advantageously consider the forecasted limitations on the capacity of the various system resources, such as forecasted airport capacity limitations including both airport arrival capacity limitations and airport departure capacity limitations and gate limitations, as well as forecasted limitations on the capacities of the air traffic control sectors. Additionally, the system, method and computer program product of the present invention can accommodate the complete set of responses, such as the ground delay, re-routing and cancellation options, that may be employed in the event that a condition, such as a weather event, a system outage or the like, causes the original flight schedule to be disrupted.

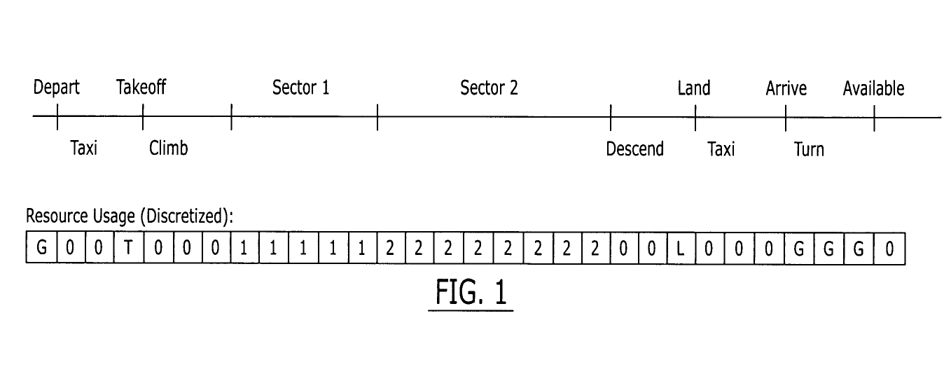

In order to represent the various system elements required for a flight, a flight plan timeline can be constructed for each flight leg. As shown in FIG. 1, the flight plan timeline for a respective flight leg may extend from the departure point at which the aircraft backs away from the gate to an available time at which the aircraft again becomes available following its arrival at the gate at another airport and the completion of the servicing of the aircraft. Thus, the flight plan timeline is complete. The flight plan timeline is also aggregated in the sense that the flight plan timeline includes the major events that occur before, during and after the flight as well as the system resources utilized during different portions of the flight, but does not include the more fine structure of airways and waypoints that are subsumed within the various air traffic control sectors.

As shown in FIG. 1, by way of example, the flight plan timeline may begin at the time of departure from a gate. The aircraft then taxis, takes off and climbs to reach a first air traffic control sector. Thereafter, this exemplary flight enters a second air traffic control sector prior to beginning to descend and land. The aircraft then taxis to a gate and is serviced prior to becoming available for its next flight. As will be apparent, different flight plans may have a variety of different timelines and may be scheduled to fly through more or fewer air traffic control sectors.

The flight plan timeline is then temporarily discretized by dividing the flight plan into time slices that generally have an equal duration. The time slices generally have an equal length, which may be set to various values, such as five, six or ten minutes. For each time slice, the system elements utilized during the respective time slice are noted. By way of example, FIG. 1 also depicts a representation of the flight plan timeline following its temporal discretization in which G represents the aircraft at a gate, T represents the point at which the aircraft takes off, L represents the point at which the aircraft is landing, 1 represents the passage of the aircraft through the first air traffic control sector and 2 represents the passage of the aircraft through the second air traffic control sector. As will be noted, the system elements utilized during the flight leg are airport gates, airport departure, first and second air traffic control sectors and aircraft arrival. The coupling of a system element with a respective time slice, thereby indicating that the system element will be utilized during the respective time slice, will be considered a system resource and may be forecast to have a limited capacity as described herein. While the duration of the time slices may be set to various values, the system, method and computer program product of one embodiment of the present invention assume that only a single system element is utilized during a respective time slice; an assumption that has increased validity for smaller time slices. However, the system, method and computer program product of other embodiments of the present invention need not be similarly premised upon this same assumption and, instead, may permit multiple system elements to be utilized during a respective time slice, thereby obviating any preference for shorter time slices.

As discussed in more detail below, the system, method and computer program product of the present invention will identify a number of alternatives to the scheduled flight leg that cause the flight plan timeline depicted in FIG. 1 to be delayed (which essentially translates the same flight plan to a subsequent time), rerouted (which may cause the air traffic control sectors through which the aircraft will fly to change), or be cancelled. The alternatives to a scheduled flight leg are termed “leg replicants.” The manner in which the system, method and computer program product of the present invention determines which of the leg replicants is employed is also described below.

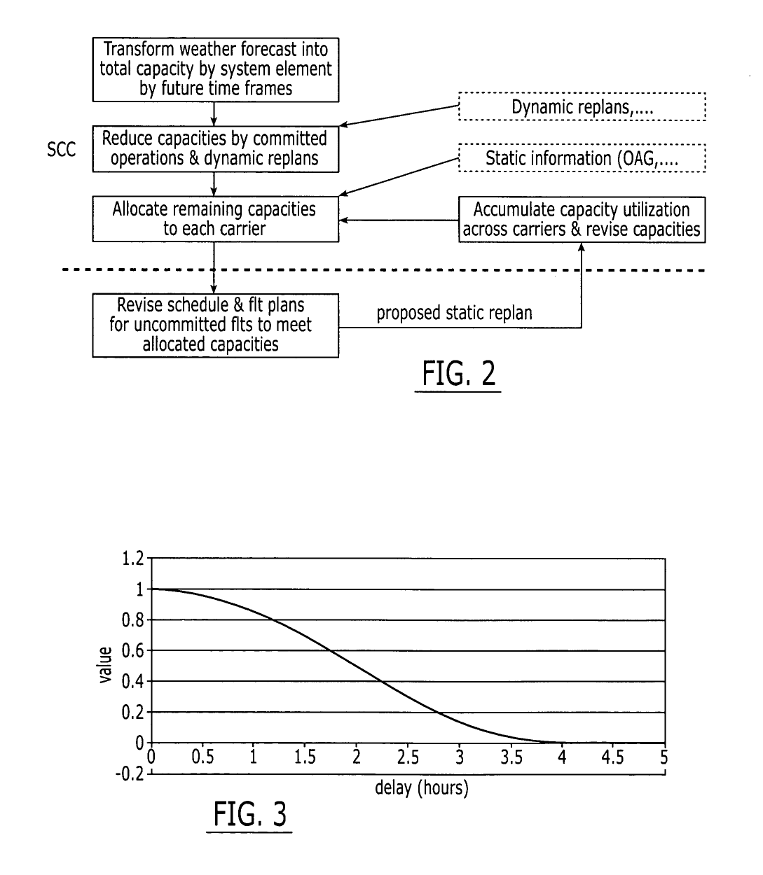

The system, method and computer program product of the present invention receive a number of inputs. One input is the system resources and the forecasted capacity of each system resource. As indicated by FIG. 2, the forecasted capacity of each system resource and the allocation of the forecasted capacity of each system resource allotted to each airline may be provided by a centralized authority, such as an air traffic control (ATC) system command center (SCC). In the embodiment described hereinbelow, the airline schedule recovery implemented by the system, method and computer program product of the present invention is applicable to all uncommitted flights and it is assumed that a separate planning process exists for dealing with a previously committed flight, such as indicated by the reference to dynamic replans in FIG. 2. In this regard, an uncommitted flight is generally defined as a flight that has not yet departed. However, an uncommitted flight may be defined somewhat differently in order to account for time delays between the planning process and the execution of the airline schedule recovery plan, if so desired. Although committed operations are not considered during the following description of one embodiment of the system, method and computer program product of the present invention, the system, method and computer program product of the present invention can likely be extended to include replans of the committed operations, if so desired.

In the illustrated embodiment in which the airline schedule recovery is applied to all uncommitted flights, the SCC initially reduces the total forecasted capacity of each system resource by the amount that the respective system resources are predicted to be utilized by the committed operations during the respective time slice. The forecasted capacities of the system resources that are available following this reduction are then allocated to the different airlines. This capacity allotment to each airline shall hereinafter be described as an allocation of the forecasted capacity of each system resource. Although this airline allocation may be performed in various manners, the allocation of the forecasted capacities of the system resources could be performed by applying a ration by schedule concept. In this regard, the ration by schedule process is generally motivated by the concept that, within a respective local region, each airline is effectively granted a portion of the forecasted capacity of each system resource within the respective local region that is proportionate to the uncommitted flights scheduled by a respective airline within the respective local region in relation to the total number of uncommitted flights that are scheduled by all airlines within the respective local region. The ration by schedule concept may also be employed on a more global basis, as opposed to the local basis described above. In this regard, airlines having a greater percentage of scheduled flights in and around one or more specific airports, such as the hub airports for the airline, may be provided with a greater proportion of the forecasted capacity of the system resources at those specific airports and in the air traffic control sectors surrounding those specific airports and a lesser proportion of the forecasted capacity of the system resources in and around other airports and in the air traffic control sectors remote from those specific airports. Thus, the proportionate share of the forecasted capacities of the system resources may essentially be traded off between the various airlines such that the airlines have greater shares of the forecasted capacities of the system resources in those regions in which they conduct more flights, thereby potentially leading to an improved or more efficient and/or more timely airline schedule recovery process.

Regardless of the manner in which the SCC determines the allocation of the forecasted capacities of the system resources to be allotted to each airline, the forecasted capacities of the system resources to be allocated to each airline are provided to the system, method and computer program product of the present invention. The system, method and computer program product of the present invention also receives a list of the aircraft itineraries that include scheduled flight legs that remain uncommitted and that must therefore be rescheduled.

An additional input to the system, method and computer program product of the present invention is the scoring function utilized to value the leg replicants, i.e. the alternative flight legs. In one embodiment, the value of a flight leg is the product of: (1) the distance of the flight leg, typically the great circle distance in miles, (2) the capacity of the aircraft in terms of seats (or, if the aircraft is used entirely or partially for cargo, a conversion factor may be utilized to convert the cargo space, such as measured in tons, into an equivalent measure of seats) and (3) the value of an objective function that varies based upon the arrival delay. The value generated by the scoring function may be referenced as effective seat miles and gives greater weight to longer flights and to larger flights. As shown by way of example in FIG. 3, the objective function relates the value of the objective function to the arrival delay. While the system, method and computer program product of the present invention may utilize various objective functions, the illustrated objective function has an S-shape that degrades from a value of one with no arrival delay to a value of zero for an arrival delay of four hours. Thus, any flight that would have an arrival delay of four hours or more, such as a cancelled flight, would have an objective function value of zero and the overall value of the flight leg, i.e., the effective seat miles, would correspondingly be zero. It is noted that the S-shape of the curve of FIG. 3 reflects the determination that multiple small delays may be less costly than a single large delay. As will be apparent to those skilled in the art, other objective functions can be utilized including objective functions having the same shape but degrading over either a shorter or longer period of time, or an altogether different shape. Moreover, different objective functions may be utilized in conjunction with different flight legs if arrival delays are more or less significant in conjunction with certain flight legs. In the illustrated example, however, the objective function is defined by a truncated normal distribution having a mu (μ) of 2 and a sigma (σ) of 1.046. In any event, the objective function provides at least some quantitative measure for making arrival delays commensurate with cancellations.

As foretold by the rationing of the system resources between the airlines, the system, method and computer program product of the present invention generally separately perform the airline schedule recovery process for each airline. As set forth below, the system, method and computer program product of the present invention may employ an identical methodology for the development of the airline schedule recovery plan for each airline. However, the system, method and computer program product of the present invention may be customized to tailor the airline schedule recovery process for specific airlines. In this regard, different airlines may utilize different objective functions based upon their perception or experience with the degradation in the value of a flight as the arrival delay increases. Additionally, some airlines may choose to not avail themselves of the full range of options that are otherwise available for airline schedule recovery by electing to utilize only a subset of the ground delay, flight rerouting and cancellation options.

For each aircraft itinerary that originally included a flight leg that remains uncommitted for a respective airline, however, the system, method and computer program product of the present invention determine a set of flight legs and, advantageously, the most desirable set of flight legs from which to construct a schedule for the respective aircraft itinerary by taking into account the ground delays and cancellations that have occurred in response to a disturbance, such as a weather event, a system outage or the like. As shown in FIG. 2, the new schedule produced by the system, method and computer program product of the present invention may be provided to the SCC and the SCC can then reevaluate the allocation of the forecasted capacities of the system resources that is provided to each airline based, not upon the originally scheduled but uncommitted flights as described above, but based upon this new schedule. This iterative process can continue in order to refine the schedule produced by the system, method and computer program product of the present invention, if so desired.

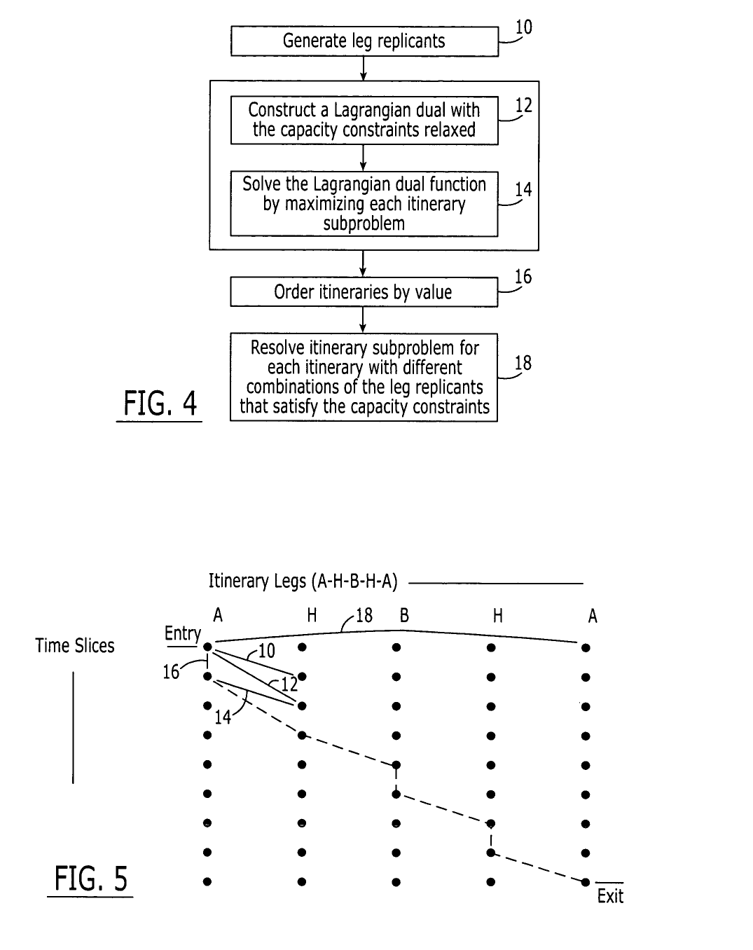

After receiving the inputs including the aircraft itineraries, the system, method and computer program product generate the alternatives or leg replicants that are possible for each flight leg of each aircraft itinerary. See block 10 of FIG. 4. As used herein, an itinerary refers to the series of flights for a particular aircraft, such as in the example provided above in which an aircraft travels from Point A to Point B to Point C and back to Point A. In the embodiment of the system, method and computer program product of the present invention that is hereafter described, the itineraries remain fixed. However, the particular flight legs of an itinerary that are selected from among the leg replicants may vary to facilitate the schedule recovery. By way of example, FIG. 5 depicts some of the leg replicants for the first leg of an itinerary for an aircraft scheduled to travel from A, to H, to B, to H and then to A again. For example, the leg replicants for the first leg include, but are not limited to: (1) a flight 10 from A to H by a first route; (2) a flight 12 from A to H by a second route; (3) a flight 14 from A to H after a ground delay 16; and (4) a cancellation 18 without any delay. As these exemplary leg replicants indicate, the leg replicants are generally variations of the original flight leg that have been delayed by one or more time slices, re-routed or cancelled altogether. The illustrated leg replicants represent just a small fraction of the leg replicants that are possible and that will be generally considered by the system, method and computer program product of the present invention. One possible itinerary that includes yet another first leg is shown by a dashed line that incorporates ground delays during the first time at A, at B and then during the second time at H.

The possible combinations of leg replicants that could be identified to form an itinerary are generally large in number. By way of example, an itinerary having four legs could alternatively be formed by all feasible permutations of the leg replicants for each of the four flight legs.

Among the multitude of combinations of leg replicants from which the schedules for the various aircraft itineraries could be constructed, the system, method and computer program product of the present invention determine the sets of flight legs (from among the corresponding leg replicants) from which the respective itineraries are constructed in such a way that the resulting itineraries have the highest overall value as determined by the consideration of the sum of the effective seat miles for each flight leg as described above. Mathematically, this optimization is a primal problem that can be expressed as the maximization of v·x, wherein v is a vector of values for the various leg replicants where the value of a respective leg replicant is defined by the effective seat miles as described above. On the other hand, x is a vector configured to select one leg replicant for each flight leg of each itinerary. Thus, the product of v and x is the cumulative value of the itineraries with each itinerary formed by a combination of the leg replicants for the flight legs of the respective itinerary.

This primal problem, that is, the maximization of the product of v and x, is subject to the constraint that x must be feasible, i.e., xεF wherein F is the set of feasible schedules for the itineraries. As used herein, the set F implies that the schedule for an itinerary is flyable, such as by insuring that the prior flight is at the gate at least a predetermined time prior to the departure of the aircraft on a subsequent flight to ensure that sufficient time is provided to service the aircraft, and does not take into consideration the forecasted capacities of the system resources. Additionally, the primal problem is subject to the constraint that: A·x≦Cap. As used herein, A is a capacity constraint matrix in which the rows of A represent a particular system resource. By way of example, one exemplary, albeit relatively small, matrix A is set forth below in the context of the mathematical relationship of A·x≦Cap:

$$A \cdot x = [ \begin{matrix}11001000 \\ 00110100 \\ 10100010 \\ 01010001\end{matrix} ] \cdot [ \begin{matrix}{x}_{1} \\ {x}_{2} \\ ⋮ \\ {x}_{8}\end{matrix} ] \leq [ \begin{matrix}\begin{matrix}\begin{matrix}{cap}_{1} \\ {cap}_{2}\end{matrix} \\ {cap}_{3}\end{matrix} \\ {cap}_{4}\end{matrix} ] = cap$$

For this exemplary matrix A, the first row could represent a first system element, e.g., a first air traffic control sector, at a first time slice and the second row could represent the same first system element, e.g., the first air traffic control sector, at a second time slice. Additionally, the third row could represent a second system element, e.g., arrivals at a first airport, at the first time slice and the fourth row could represent the same second system element, e.g., arrivals at the first airport, at the second time slice. The number of rows in the matrix A would generally be much larger than depicted above since a separate row would typically be required for each system element for each different time slice.

The columns of the matrix A represent different respective leg replicants for each flight leg of each itinerary. For example, the leftmost column may represent a first leg replicant for a first flight leg of a first itinerary that would require the use of the first and second system elements during the first time slice. In contrast, the rightmost column of matrix A may represent the fourth leg replicant for a second flight leg of the first itinerary that requires only the second system element during the second time slice.

As shown above, the decision vector x has the same number of elements as the number of columns of the matrix A. Moreover, the capacity allocation vector cap has the same number of elements as the number of rows in the matrix A with each element of the capacity allocation vector cap equaling the airlines's allocation of the forecasted capacity for the respective system resource. As shown, this constraint upon the primal problem prevents the leg replicants that are being considered from consuming more system resources than are forecasted to be available to the airline. In order to simplify the subsequent processing, however, those system resources that have no remaining forecasted capacity and those system resources that have a forecasted capacity that can never be exceeded may be eliminated as constraints, and those leg replicants that would require either system resources that have no remaining forecasted capacity may likewise be eliminated from consideration.

The primal problem may be solved in various manners. For example, the primal problem may be formulated as an integer linear problem and solved using commercially available software. According to one advantageous embodiment of the system, method and computer program product of the present invention, however, Lagrangian relaxation is employed to solve the primal problem in a manner that identifies a solution for the primal problem that is extensible and that can be performed in a fraction of the time required to otherwise solve the problem with commercially available software.

By way of background, Lagrangian relaxation is a widely utilized technique for solving difficult combinatorial optimization problems as described by J. E. Beasley, Lagrangian Relaxation, In Modern Heuristic Techniques for Combinatorial Problems, edited by C. R. Reeves, pp. 243-303, John Wiley & Sons, Inc., New York, N.Y. (1993). In Lagrangian relaxation, a subset of constraints, typically the difficult constraints, is targeted for relaxation by multiplying each constraint by a value termed the Lagrange multiplier or dual variable and moved into the objective function. The relaxed problem with its new objective and remaining easy constraints is then generally much easier to solve than the original problem. This solution of the relaxed problem provides an upper bound on the optimal objective function for the original combinatorial optimization problem. Thus, it is desirable to determine the values of the dual variables that minimize the objective function of the relaxed problem in order to more tightly define the optimal objective function of the original combinatorial optimization problem. Based upon values of the dual variables that minimize the objective function of the relaxed problem, a primal x can be recovered, although the primal x may be infeasible due to the relaxation of the constraints as described below. The problem of finding values of the dual variables that minimize the objective function of the corresponding relaxed problem is called solving the Lagrangian dual and is generally solved by nonsmooth optimization techniques, as known to those skilled in the art.

In this embodiment of the present invention, the capacity constraints are relaxed to facilitate the solution of the primal problem. As such, a Lagrangian dual is constructed in which a dual variable u is assigned to the capacity of each system resource such that the capacity constraints of the original primal problem are relaxed. See block 12 of FIG. 4. For a fixed dual variable u greater than or equal to zero, the primal problem may be expressed as a relaxed problem as follows:

$${max}_{x ∈ F} \{ u \cdot cap + ( v - u \cdot A ) \cdot x \}$$

wherein F imposes the constraints that the selected flight legs are flyable in that a subsequent flight is not scheduled to depart any earlier than the availability time of the aircraft and that at most one leg replicant is selected for each flight leg (wherein the selection of no flight leg exists in the instance of a cancellation).

The dual variable is generally not fixed, but is, instead, iteratively varied in order to minimize the Lagrangian dual function. As such, the dual problem can be expressed as the minimization of the Lagrangian dual function as follows:

$${min}_{u \geq 0} \{ u \cdot cap + {max}_{x ∈ F} ( v - u \cdot A ) \cdot x \}$$

wherein the function within the brackets is termed the Lagrangian dual function. The solution of the Lagrangian dual problem can be rewritten as follows:

$${min}_{u \geq 0} \{ u \cdot cap + {\sum }_{I} {max}_{x ∈ F} ( {v}^{I} - u \cdot {A}^{I} ) \cdot {x}^{I} \}$$

wherein I represents a respective itinerary. Thus the Lagrangian dual function advantageously decomposes into separate problems for each aircraft itinerary, thereby somewhat simplifying the requisite processing. For each aircraft itinerary, the various combinations of leg replicants (one for each flight leg of the itinerary) are therefore evaluated in order to determine the combination of leg replicants, which maximizes the itinerary sub-problem, i.e., which maximizes (v^{I}−u·A^{I})·x^{I}. See block 14. With reference to FIG. 4, the longest path through the acyclic network is generally identified to maximize the itinerary sub-problem with the value of the path equaling the sum of an adjusted value for each leg of the path and with the adjusted value of a respective leg equaling the value v of the leg less the product of the dual variables u and the respective elements of the capacity constraint matrix A. As indicated by the immediately preceding equation, the maximum values for the itinerary sub-problems for each aircraft itinerary that includes an uncommitted flight leg are then summed and added to the product of the dual variables and the capacity vector. The vector of dual variables which minimize this sum is then determined to solve the Lagrangian dual function.

The solution of the Lagrangian dual problem as briefly described above provides the Lagrange multiplier or dual variables which are represented as a vector with one element of the resulting vector corresponding to each system resource. Additionally, the solution of the Lagrangian dual function provides the bound on the primal problem. Unfortunately, the particular combinations of leg replicants that are selected as the flight legs of the itineraries that minimize the Lagrangian dual function may not define a feasible solution to the original problem since the resulting flight legs of the itineraries may collectively exceed the allocation of the forecasted capacity for one or more of the system resources. As such, a Lagrangian heuristic is employed to again evaluate the leg replicants for the flight legs of the itineraries in order to identify the sets of flight legs from among the leg replicants from which to construct schedules for the itineraries that are both desirable and feasible.

In this regard, the itineraries that include at least one scheduled, but uncommitted flight leg are ordered in terms of the value of each itinerary, with the itinerary having the highest value being ranked first, and the itinerary having the lowest value being ranked last. See block 16. While different valuation techniques for the itineraries may be utilized, the system, method and computer program product of one embodiment assign a value to each flight leg of an itinerary that is based upon the product of the great circle distance of the flight leg in miles and the capacity of the aircraft in terms of seats such that the largest aircraft flying the longest route is considered to have the highest value, and the smallest aircraft flying the shortest route is considered to have the lowest value. The value for each flight leg of an itinerary is then summed to determine the value of the itinerary.

Beginning with the itinerary having the largest value, the itinerary subproblem is then re-solved for the various different combinations of leg replicants that could be selected for the flight legs of the itinerary. See block 18. During this re-solving of the Lagrangian dual function, the dual variable is set to the value of the Lagrangian multiplier that was previously determined during the solution of the Lagrangian dual function. Moreover, the leg replicants that require the use of a system resource that has no available capacity are eliminated from consideration to simplify processing and to insure that the solution is feasible. The combination of leg replicants that constitute the maximum solution to the itinerary subproblem may then be utilized to construct a schedule for the respective itinerary. The allocation of the capacity that is forecast for the system resources is then reduced in each time slice for the system resources that will be utilized by the respective itinerary. This process is continued by sequentially considering the itineraries and correspondingly reducing the allocation of forecasted capacity of the system resources based upon the resulting flight legs that constitute the itineraries that have been considered to date.

When all of the itineraries have been considered without exceeding the allocation of the forecasted capacity of the system resources at any time slice, the set of schedules for the itineraries identified by the Lagrangian heuristic is feasible and will be returned as the preferred airline scheduled recovery approach.

The embodiment of the system, method and computer program product of the present invention that was described above assigns a value to each flight leg of an itinerary in a manner that is independent of the value assigned to other flight legs of the same or different itineraries. Other embodiments of the system, method and computer program product of the present invention may be developed such that the values assigned to the various flight legs take into consideration the effect of the particular flight leg on other flight legs. For example, a lower value may be assigned to a flight leg that has been delayed to such an extent that at least some of the passengers will miss a connecting flight. Additionally, the embodiment of the system, method and computer program product of the present invention described above requires that the airline schedule recovery process utilizes the same aircraft to fly between the same cities as originally scheduled, i.e., the same aircraft itineraries are maintained. As will be apparent to those skilled in the art, the system, method and computer program product of other embodiments of the present invention may not be so limited and, may instead, permit aircraft to be interchanged in various ways. For example, instead of requiring the same aircraft to fly between the same cities as scheduled, the system, method and computer program product may merely require the same type of aircraft to fly between the same cities as scheduled or may not impose any limitation upon the particular aircraft or the type of aircraft that flies the scheduled routes.

In this regard, in the embodiment of the system, method and computer program product described hereinafter, the airline schedule recovery process may permit aircraft to be interchanged or swapped. More generally, this allows aircraft itinerary to be changed as part of the recovery process. In one embodiment, for example, aircraft of a compatible type may be interchanged. The definition of compatibility can be established so as to provide more or less flexibility in the types of aircraft that can be interchanged. For example, aircraft may be considered compatible and therefore capable of being interchanged only if the aircraft are of the same type. Alternatively, a broader definition of compatibility that provides more flexibility may be established in that aircraft may be defined to be compatible if the aircraft are of the same aggregated equipment type such that the aircraft are operationally equivalent. In this vein, operational equivalency is intended to include aircraft that generally have the same flight times and turn times, that is, the same time in general is required to fly the same routes and to service the aircraft following a flight so as to be prepared for a subsequent flight. A database may be constructed that identifies each aircraft within a fleet as well as the other aircraft that are compatible therewith.

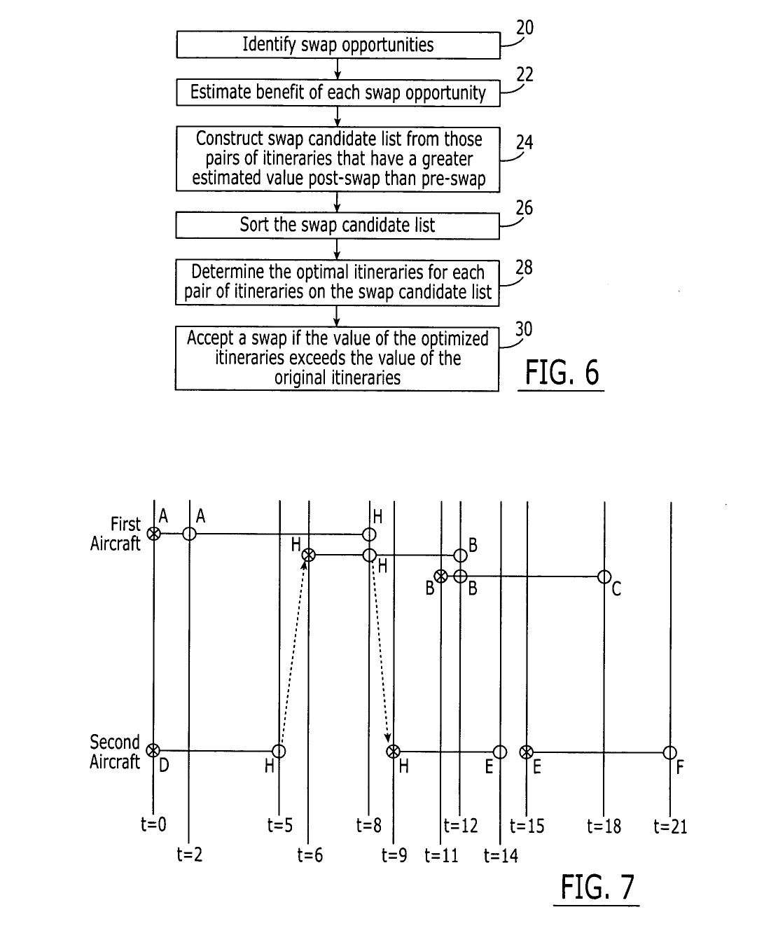

In this embodiment, the airline schedule recovery process is initially performed as described above so as to optimize the fixed itinerary schedules without swapping aircraft. Thereafter, an additional routine is performed to identify improvements in the airline schedule recovery process that can be brought about by interchanging or swapping compatible types of aircraft. In this regard, the airline schedule that is produced via the initial airline schedule recovery process described above is searched to identify viable opportunities for swapping aircraft in order to provide alternative itineraries that may or may not be advantageous, as described below. See block 20 of FIG. 6. These swap opportunities are identified in instances in which two aircraft of the same compatible type are on the ground at the same airport at a similar time.

A relatively simple example of a swap opportunity is provided with reference to FIG. 7. As shown, the itinerary of a first aircraft includes a first flight with a scheduled departure from airport A at time t=0 that has been delayed until an actual departure at time t=2. In this regard, FIG. 7 denotes scheduled departures with a circle with an “X”. This first flight for the first aircraft arrives at airport H (a hub airport) and is serviced, at least minimally, so as to be prepared for a subsequent flight by time t=8. Time t=8 is referred to as the availability time for the first aircraft at airport H since time t=8 is the earliest time at which the first aircraft is available for a subsequent flight. The second flight for this first aircraft is scheduled to depart from airport H at time t=6, but this departure has been rescheduled to time t=8. This rescheduled second flight is now slated to arrive at airport B and be available for a subsequent flight by time t=12. Thus, the third flight of the first aircraft from airport B to airport C that was originally scheduled to depart at time t=11 has also been delayed and rescheduled to depart at time t=12 so as to arrive at and be serviced so to be available for a subsequent flight from airport C at time t=18.

Additionally, the itinerary for a second aircraft that has not experienced any delays begins with a scheduled departure from airport D at time t=0 and arrives at airport H so as to be available for a subsequent flight by time t=5. The second aircraft then remains on the ground at airport H until time t=9 at which time the second aircraft is scheduled to depart for airport E. The second aircraft is scheduled to arrive at airport E and be serviced so as to be prepared for a subsequent flight by time t=14. However, this second aircraft remains on the ground at airport E until time t=15 at which point it departs to airport F. This second aircraft is scheduled to arrive and be available at airport F at time t=21.

Assuming that the first and second aircraft are compatible, the first and second aircraft present a swap opportunity since both are scheduled to be on the ground at airport H at the same time. As indicated by the dashed lines in FIG. 7, the tail ends of the itineraries of the first and second aircraft (consisting, in this example, of the second and third flights for each aircraft) may be swapped such that the second aircraft flies from airport H to airport B and subsequently from airport B to airport C to complete the flight legs that the first aircraft was originally intended to service. In a like manner, following a swap, the first aircraft will fly from airport H to airport E and subsequently from airport E to airport F to complete the flight legs that the second aircraft was originally scheduled to fly. By swapping the aircraft, the flight legs from airport H to airport B and subsequently from airport B to airport C need not be delayed.

The criteria under which two compatible aircraft are considered to present a swap opportunity can be implemented in several manners. In one embodiment, an itinerary of the first aircraft is identified that includes at least two legs L₁ and L₁ₓ with L₁ₓ immediately following L₁. In order to be a candidate for a swap in accordance with this embodiment, the subsequent flight leg L₁ₓ must have a propagated delay. In this regard, a propagated delay is a delayed departure that has been rescheduled to occur at the earliest possible time following the arrival of the previous flight leg and the turning of the aircraft with the minimal necessary degree of service. In this regard, the availability time of a flight leg is considered the earliest time at which the aircraft is available for a subsequent flight following arrival of the aircraft and performance of the minimum necessary amount of service upon the aircraft. As such, the subsequent leg L₁ₓ will be considered to have a propagated delay if the availability time of L₁ equals the departure time of L₁ₓ.

Once an appropriate pair of flight legs L₁ and L₁ₓ have been identified, the itineraries of all of the other compatible aircraft are reviewed to identify potential swap opportunities. In this regard, the itineraries are reviewed to identify itineraries having at least two flight legs L₂ and L₂ₓ, with L₂ₓ being the flight leg that occurs immediately following L₂. In identifying flight legs L₂ and L₂ₓ, the destination airport of fight leg L₂ must be the same as the destination airport of flight leg L₁ such that both aircraft are at the same airport. Furthermore, the availability time of flight leg L₂ must be prior to the availability time of flight leg L₁ since otherwise any potential swap would not be capable of improving the overall schedule. Additionally, the absolute value of the difference between the originally scheduled departure times of flight legs L₁ₓ and L₂ₓ must be less than some predefined value, wherein this predefined value defines the window of time in which both aircraft must be on the ground at the same airport to effectuate a swap. This predefined value may be adjusted depending upon the application so as to promote more or fewer swaps.

This process of identifying swap opportunities repeats until all potential swap opportunities have been evaluated. For example, for an airline having a fleet of aircraft, each of which have an itinerary developed via the aircraft schedule recovery process described above, the itinerary of a first aircraft is evaluated and, in particular, the first two flight legs of the first itinerary are evaluated to determine if the second flight leg has a propagated delay. If so, the first two flight legs of the first aircraft are designated L₁ and L₁ₓ. The flight legs of each of the other itineraries are then evaluated in a pair wise manner to determine each potential swap opportunity such that multiple swap opportunities may be identified with respect to L₁ and L₁ₓ. After identifying all swap opportunities for the first L₁ and L₁ₓ pair, the second and third legs of the first itinerary are evaluated to determine if the third leg has a propagated delay such that the second and third leg qualify as L₁ and L₁ₓ. The flight legs of all of the other itineraries are then reviewed in a similar manner to identify swap opportunities. Once each consecutive pair of flight legs of the first itinerary has been examined to determine if the subsequent flight leg of the pair has a propagated delay and if so, to identify each of the swap opportunities presented by the other itineraries, each consecutive pair of flight legs of the second itinerary is examined in the same manner, followed by an examination of each consecutive pair of flight legs of the third itinerary and so on.

Once each of the swap opportunities have been identified, the benefit of making each swap is estimated. See block 22 of FIG. 6. In estimating the benefit of making each swap, the estimate is made under the assumption that the propagated delay can be reduced, if not eliminated, if an aircraft is made available to fly the subsequent flight leg at an earlier point in time. While the benefit of making a swap may be estimated in various manners, the value of each of the affected itineraries following the proposed swap may be defined by the sum total of the effective seat miles of the itineraries following the swap with the effective seat miles being computed as described above. Likewise, the effective seat miles of the original itineraries of the same two aircraft prior to the swap are summed and a determination is made as to whether the total effective seat miles following the swap exceeds the total effective seat miles prior to the swap. If the total effective seat miles following the swap exceed the total effective seat miles prior to the swap, the itineraries of the aircraft following the swap are placed in a swap candidate list along with the respective estimated benefit provided by the potential swap. Otherwise, the swap opportunity under consideration is not placed on the list. See block 24. Once the estimated benefit of each of the potential swaps has been determined, the swap candidate list is sorted in accordance with the estimated benefit provided by the potential swaps. See block 26.

As the benefits of each potential swap have heretofore been only estimated, the benefit of each potential swap in the swap candidate list is now defined more exactly starting with the potential swap having the largest estimated benefit. In this regard, one of the results of the airline schedule recovery process described above was the determination of the capacity of each system resource and the corresponding capacity usage during each time slice. In order to evaluate more precisely the benefit accorded by the potential swap having the largest estimated benefit, the capacities utilized by the flight leg(s) of the itineraries that are proposed to be swapped to another aircraft (i.e., the flight legs at the tail ends of the itineraries) are reinstated, thereby increasing the available capacities and correspondingly decreasing capacity usage. For one of the itineraries involved in the potential swap (for example, for the itinerary of the second aircraft of FIG. 7 that includes, following the potential swap, a first flight leg from airport D to airport H, a second flight leg from airport H to airport B and a third flight leg from airport B to airport C), the optimal itinerary is then determined in the same manner as described above in which a plurality of leg replicants are determined for those flight legs that have been swapped (for example, the flight legs from airport H to airport B and then from airport B to airport C) and the combination of leg replicants which maximizes the itinerary subproblem, i.e., (v^{I}−u·A^{I})·x^{I}, is subsequently determined. As noted above, the maximization of the itinerary subproblem corresponds to the determination of the longest path through an acyclic network such as shown in FIG. 4.

Once the optimal itinerary for one of the aircraft involved in the potential swap has been determined by maximizing the itinerary subproblem, the capacities for the system resources utilized by the optimal itinerary are reduced and the itinerary of the other aircraft involved in the proposed swap is similarly evaluated, such as by determining the plurality of leg replicants for the flight legs that have been swapped and thereafter maximizing the respective itinerary subproblem. See block 28. The capacities for the system resources utilized by this optimized itinerary are also correspondingly reduced. In constructing the optimal itineraries, the itinerary of either aircraft may be constructed first. In one embodiment, however, the itinerary of the aircraft that includes (after the swap) the flight leg that previously experienced propagated delay may be initially constructed to increase the likelihood that the propagated delay is reduced, if not eliminated. Once the optimized itinerary for each aircraft involved in the potential swap has been determined, the value of each optimal itinerary is determined. This value may be determined in various manners, but is typically defined to be the sum of the estimated seat miles for the optimal itineraries, as described above. The value for the optimal itineraries involved in the potential swap is compared to the sum of the values of the original itineraries for the same aircraft prior to the proposed swap. In instances in which the value of the itineraries involved in the proposed swap exceeds the value of the original itineraries prior to this swap, the swap is accepted. See block 30.

If, however, the value of the itineraries for the aircraft that are involved in the swap is less than the sum of the values of the original itineraries for the same aircraft prior to the swap, the swap is not culminated and the system capacities for each time slice are recomputed so as to reinclude the capacities otherwise utilized to effectuate the swap and to again take into account the capacity usage of the original itineraries of the aircraft prior to the swap. Thereafter, the next potential swap in the swap candidate list is evaluated to determine if the swap is beneficial. If, however, any potential swap in the list includes an itinerary that has previously been utilized in a prior swap that has been identified as being beneficial and has been accepted, the subsequent potential swap that utilizes that same itinerary is skipped and not evaluated.

Once the entire swap candidate list has been evaluated, the process of identifying swap candidates, constructing a swap candidate list by estimating the benefits of the swap candidates and thereafter optimizing the itineraries of the aircraft involved in the potential swaps to determine if the potential swap is truly beneficial and should be accepted may be repeated in accordance with the same process described above to determine if the schedules (which now include itineraries that have been identified to be a beneficial swap) can be further improved. This process may be repeated until any predefined termination condition is reached. Exemplary termination conditions include evaluating a predetermined number of potential swaps, constructing and evaluating a predetermined number of swap candidate lists, examining a swap candidate list without identifying any beneficial swaps, or the like. Once the termination condition is reached, those itineraries that comprise a beneficial swap are accepted with the itineraries included in those beneficial swaps now representing the scheduled itineraries for the respective aircraft.

The additional refinement of the airline schedule recovery process described above may be beneficial for numerous reasons. In the first instance, the result of this refined process of swapping between compatible types of aircraft results in itineraries that are at least as effective and, in many instances, more effective than those that are determined without consideration of swapping. This refinement also has relatively low memory requirements and imposes processing requirements that can be controlled in numerous different ways including, for example, variations in the definition of compatible types of aircraft and the definition of termination criteria. Moreover, this refinement permits greater flexibility in recovering from unanticipated events that create impediments to the original airline schedule.

As described above, the refinement to the airline schedule recovery process to permit swapping of compatible types of aircraft can be performed as a secondary or additional routine following the initial airline schedule recovery process described above. Alternatively, the consideration of swapping between compatible types of aircraft can be incorporated into the initial routine in which the optimized set of schedules is originally defined. In this embodiment, the construction of optimized itineraries is permitted with the flight legs that will comprise the respective itineraries being selected from a pool of flight legs in which all flight legs within the pool are flown by a compatible type of aircraft. In this regard, the definition of compatibility may vary from application to application with some applications defining compatible types of aircraft to be the same type of aircraft, and other applications defining compatible types of aircraft to be aircraft that is operationally equivalent.

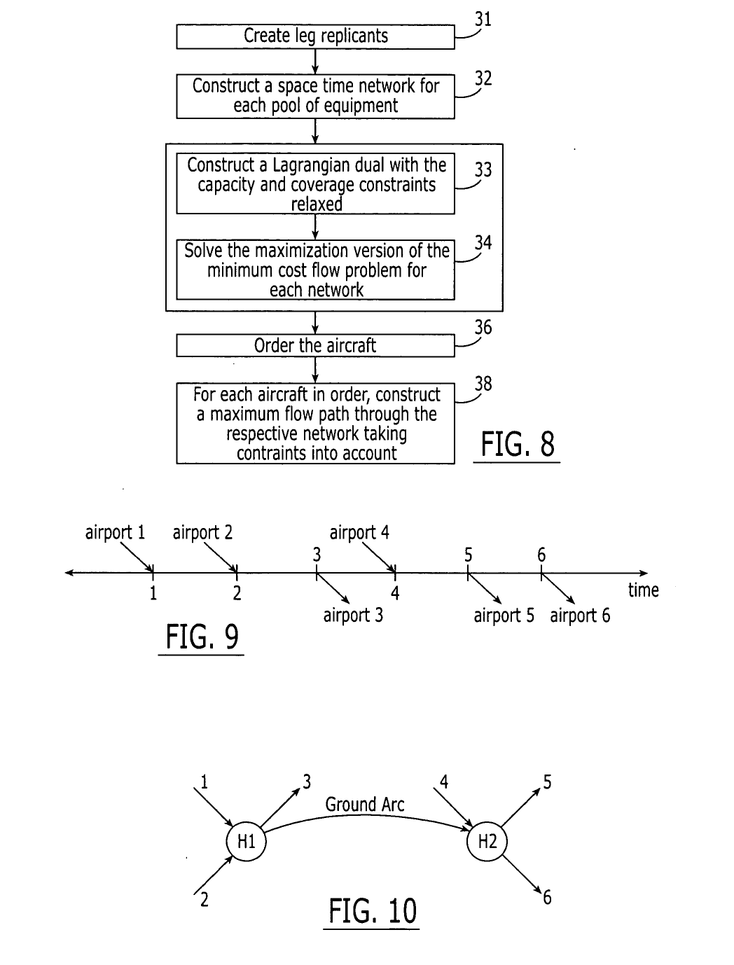

As in the initial discussion of the airline schedule recovery process, a Lagrangian relaxation technique is utilized in which the capacity constraints are relaxed. Additionally, the constraint that otherwise requires that there is at most one leg replicant per flight leg is also relaxed to permit multiple leg replicant with each leg replicant consisting of a departure time, an arrival time, an availability time and a flight path. Thus, within a pool, multiple leg replicants for the same flight leg may co-exist. See block 31 of FIG. 8.

The constraint relating to the number of strategies or leg replicants per flight leg may be represented as: B·x≦1. As used herein, B is a matrix in which the rows of B represent a respective flight legs and the columns of B represent leg replicants. Additionally, 1 is a vector of ones. By way of example, one exemplary, albeit relatively small, matrix B is set forth below in the context of the mathematical relationship of B·x≦1:

$$B \cdot x = [ \begin{matrix}11000000 \\ 00110000 \\ 00001100 \\ 00000011\end{matrix} ] \cdot [ \begin{matrix}{x}_{1} \\ {x}_{2} \\ ⋮ \\ {x}_{8}\end{matrix} ] \leq [ \begin{matrix}\begin{matrix}\begin{matrix}1 \\ 1\end{matrix} \\ 1\end{matrix} \\ 1\end{matrix} ]$$

For this exemplary matrix B, the first, second, third and fourth rows could represent first, second, third and fourth flight legs. The number of rows in the matrix B would generally be much larger than depicted above since a separate row would typically be required for each flight leg. The columns of the matrix B represent different respective leg replicants. For example, the leftmost column may represent a first leg replicant. In contrast, the rightmost column of matrix B may represent an eighth leg replicant.

As shown above, the decision vector x has the same number of elements as the number of columns of the matrix B and is designed to select at most one leg replicant for each flight leg of each itinerary. Moreover, the vector 1 has the same number of elements (all being one) as the number of rows in the matrix B such that each flight leg may only be flown once.

According to this embodiment and as shown in block 32 of FIG. 8, a space time network is then constructed. In order to better explain the space time network, a relatively simple example for a respective airport is provided with reference to FIGS. 9 and 10. In FIG. 9, a timeline extends from time t=1 to time t=6 with aircraft arriving from airports 1, 2 and 4 at times t=1, 2 and 4, respectively. Likewise, aircraft depart to airports 3, 5 and 6 at times t=3, 5 and 6, respectively. As a side note, the time denoted in conjunction with arriving aircraft is the availability time at which the aircraft has arrived and has undergone at least the minimum service required to place the aircraft in condition for a subsequent flight. While the graphical depiction of arrivals and departures at the respective airport over a period of time as depicted in FIG. 9 is relatively simplistic, a comparable timeline could be constructed for all of the various leg replicants for the flight legs included in a respective pool and for all airports.

The space time network is then constructed that includes nodes that represent the particular airport H during the particular block of time. The space time network is constructed in accordance with the rule that during the block of time associated with a respective node, all departing aircraft must depart following all arrivals except for those aircraft that remain on the ground until the time period associated with the next node. Based upon the exemplary timeline depicted in FIG. 9, the space time network of FIG. 10 may be constructed. As shown in FIG. 10, the same airport H may be represented by a first node H1 and a second node H2 with H1 representing airport H during a first period of time and node H2 representing the same airport H at a second period of time. With respect to node H1, the aircraft arrive from airports 1 and 2 prior to the departure of the aircraft to airport 3. With respect to node H2, the aircraft arrives from airport 4 prior to the departure of aircraft for airports 5 and 6. In addition, the nodes are connected by a ground arc representing an aircraft that remains on the ground between the respective time periods. A comparable network would be constructed for each pool of equipment and for all airports.

As described above in conjunction with the initial airline schedule recovery process, the optimization problem presented by the space time networks is advantageously solved by Lagrangian relaxation. In this regard, a Lagrangian dual function is constructed and repeatedly solved by non-smooth optimization. See block 33 of FIG. 8.

In this embodiment of the present invention, both the capacity constraints and the constraints that limit each flight leg to only a single strategy, i.e., a single leg replicant, are relaxed to facilitate the solution of the primal problem. As such, a Lagrangian dual is constructed in which a dual variable u is assigned to the capacity of each system resource such that the capacity constraints of the original primal problem are relaxed. In addition, a dual variable λ is assigned to the flight legs such that the constraint (termed the coverage constraint) of the original primal problem that each flight leg may have only a single replicant is also relaxed. For fixed dual variables u and λ greater than or equal to zero, the primal problem may be expressed as a relaxed problem as follows:

$${max}_{x ∈ {F}^{′}} \{ u \cdot cap + λ \cdot 1 + ( v - u \cdot A - λ \cdot B ) \cdot x \}$$

wherein 1 is a vector of ones, F′ is a feasible flow in the space time network for type t, t is a pool of equipment termed a constructed type.

The dual variable is generally not fixed, but is, instead, iteratively varied in order to minimize the Lagrangian dual function. As such, the Lagrangian dual problem can be expressed as the minimization of the Lagrangian dual function as follows:

$${min}_{u \geq 0 λ \geq 0} \{ u \cdot cap + λ \cdot 1 + {max}_{x ∈ {F}^{′}} ( v - u \cdot A - λ \cdot B ) \cdot x \}$$

wherein the function within the brackets is termed the Lagrangian dual function. The solution of the Lagrangian dual problem can be rewritten as follows:

$${min}_{u \geq 0 λ \geq 0} \{ u \cdot cap + λ \cdot 1 + {\sum }_{t} {max}_{x ∈ {F}^{′}} ( {v}^{t} - u \cdot {A}^{t} - λ \cdot {B}^{t} ) \cdot {x}^{t} \}$$

Thus, the Lagrangian dual function advantageously decomposes into separate problems for each pool of equipment, thereby somewhat simplifying the requisite processing. For each pool of equipment, the various combinations of leg replicants (one for each flight leg of the itinerary) are therefore evaluated in order to determine the combination of leg replicants, which maximizes the constructed type sub-problem, i.e., which maximizes (v^{t}−u·A^{t}−λ·B^{t})·x^{t}. In this regard, the solution of each subproblem is a (maximizing version of a) minimum cost flow problem in which the desired flow through the space-time network includes arcs (representing leg replicants for the flight legs) with associated values that are selected in such a manner that the total value of the flow is maximized. See block 34 of FIG. 8. The values of the various leg replicants for a respective flight leg may be defined in various manners, but is typically the effective seat miles adjusted by the values of the respective dual variables as represented parenthetically in the immediately preceding equation. As indicated by the immediately preceding equation, the maximum values for the constructed type subproblems for each pool of equipment that includes an uncommitted flight leg are then summed and added to the product of the dual variable u and the capacity vector and to the product of the dual variable λ and a vector of ones. The vectors of dual variables u and λ which minimize this sum are then determined to solve the Lagrangian dual function.

The solution of the Lagrangian dual problem as briefly described above provides the Lagrange multiplier or dual variables which are represented as vectors with one element of the resulting vector u corresponding to each system resource and one element of the resulting vector λ corresponding to each flight leg. Additionally, the solution of the Lagrangian dual problem provides the bound on the primal problem. Unfortunately, the particular combinations of leg replicants that are selected as the flight legs of the itineraries that minimize the Lagrangian dual function may not define a feasible solution to the original problem since the resulting flight legs of the itineraries may collectively exceed the allocation of the forecasted capacity for one or more of the system resources and/or may utilize two or more alternative leg replicants of a single flight leg. As such, a Lagrangian heuristic is employed to again evaluate the leg replicants for the flight legs of the itineraries in order to identify the sets of flight legs from among the leg replicants from which to construct schedules for the itineraries that are both desirable and feasible.

At least one embodiment employs a Lagrangian heuristic that begins by ordering the aircraft of a fleet of a respective airline. See block 36. Aircraft may be ordered in various manners, such as by placing the aircraft that have more seats and a longer range at the top of the list with aircraft having fewer seats and shorter range at the bottom of the list. Initially, all flight legs are marked as unscheduled and all forecasted system capacities for the respective airline are marked as available. The first aircraft, such as the aircraft at the top of the list, is selected and the network representative of the pool of flight legs that includes the flight legs to be flown by the constructed type of aircraft is evaluated. During this analysis of the initial aircraft, those leg replicants included in the network that are infeasible as a result of requiring more of one or more system capacities than is available during one or more time slots are removed. The remaining arcs of the network are then analyzed so as to construct the maximum value path (longest path) through the network. See block 38. As described above, the construction of the maximum value path provides the greatest value with the value capable of being defined in various manners including, for example, in terms of the effective seat miles as adjusted by the respective dual variables as described above. Once the maximum value path has been constructed through the network, the resulting path is analyzed to determine if the path utilizes two or more leg replicants for the same flight leg. If so, the maximum value path that has been constructed includes a cycle, such as a round-trip flight, that must be cancelled in order to make the resulting maximum value path feasible (by using at most a single leg replicant for each flight leg). Once the maximum value path has been determined to be feasible, the capacities for the respective system resources are adjusted in the various time slices in accordance with the usage of the system resources by the flight legs constituting the maximum value path. Thereafter, this process is repeated for each subsequent aircraft in the list. During the review of all subsequent aircraft, the network is analyzed prior to constructing the maximum value path to also remove all arcs representative of flight legs that have already been scheduled such that the resulting maximum value path is more nearly feasible and to prevent unnecessary processing.

Once all aircraft have been scheduled, this routine may be terminated. Alternatively, the order of the aircraft may be perturbed and the process repeated with a comparison being made of the respective values, such as in terms of effective seat miles, of the resulting schedule with the best schedule in terms of value being kept. This overall process may be repeated with the order of the aircraft being perturbed between each cycle any number of times until a predefined termination condition, as described above, is met.

Once schedules for the various aircraft have been constructed, a conventional tail routing itinerization routine may be employed to properly assign aircraft to the various itineraries, such as by employing first in first out logic or the like. In this regard, the airline schedule recovery process can construct an optimized set of itineraries that can then be submitted to a conventional tail routing itinerization routine in order to assign particular aircraft, i.e., tails, to the itineraries.

Thereafter, the initial airline schedule recovery process as described above may, but need not, be utilized to further optimize the schedule. As also described above, this resulting set of optimized schedules will have a cumulative value, such as based upon the sum total of the effective seat miles for the various flight legs of the plurality of itineraries.

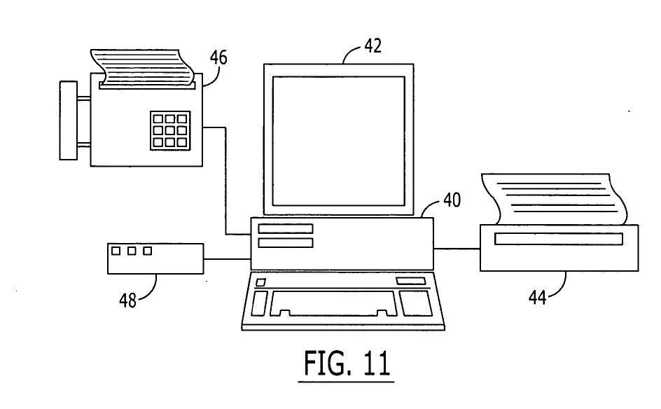

The system, method and computer program product of the present invention generally provide for airline schedule recovery as described above in an automated fashion, both for simulation purposes and/or for use as a decision support tool, as described above. As such, the system of the present invention is typically embodied by a processing element and an associated memory device, both of which are commonly comprised by a computer 40 or the like. See FIG. 11. In this regard, the method of the above-described embodiments of the present invention can be performed by the processing element manipulating data stored by the memory device in accordance with a computer software program that may also be stored by the memory device. The computer can include a display 42 and a printer 44 for presenting information relative to performing embodiments of the method of the present invention, including the various itineraries that are constructed according to embodiments of the present invention.

Also, the computer 40 can include a means for locally or remotely transferring the information relative to performing embodiments of the method of the present invention. For example, the computer can include a facsimile machine 46 for transmitting information to other facsimile machines, computers or the like. Additionally, or alternatively, the computer can include a modem 48 to transfer information to other computers or the like. Further, the computer can include an interface (not shown) to a network, such as a local area network (LAN), and/or a wide area network (WAN). For example, the computer can include an Ethernet Personal Computer Memory Card International Association (PCMCIA) card configured to transmit and receive information to and from a LAN, WAN or the like.

According to one aspect of the present invention, the system of the present invention generally operates under control of a computer program product according to another aspect of the present invention. The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, FIGS. 2, 4, 6 and 8 are flowcharts of methods, systems and program products according to the invention. It will be understood that each block or step of the flowchart, and combinations of blocks in the flowchart, can be implemented by computer program instructions. These computer program instructions may be loaded onto a computer or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that each block or step of the flowchart, and combinations of blocks or steps in the flowchart, can be implemented by special purpose hardware-based computer systems, which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. For example, the system, method and computer program product of another embodiment of the present invention may structurally decompose the primal problem prior to employing Lagrangian relaxation, if so desired. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method of determining an alternative schedule comprising:
identifying a plurality of leg replicants for at least some legs of a plurality of itineraries; and
evaluating different combinations of the leg replicants for the respective legs of the plurality of itineraries in order to construct schedules for the plurality of itineraries, wherein evaluating different combinations of the leg replicants comprises initially relaxing at least some capacity constraints.

2. A method according to claim 1 wherein evaluating different combinations of the leg replicants comprises utilizing Lagrangian relaxation to initially relax at least some of the capacity constraints and to subsequently reevaluate at least some of the different combinations while subject to the capacity constraints.

3. A method according to claim 2 further comprising assigning a value to each leg replicant.

4. A method according to claim 3 wherein assigning the value comprises assigning the value based upon at least one of distance of the respective leg, seating capacity and an objective function relating value to arrival delay.

5. A method according to claim 3 wherein evaluating different combinations of the leg replicants further comprises identifying the schedules for the plurality of itineraries that are comprised of combinations of the leg replicants that have the largest collective value.

6. A method according to claim 5 wherein identifying the schedules comprises separately determining the schedule for each itinerary that is comprised of leg replicants having the largest collective value while at least some of the capacity constraints are relaxed.

7. A method according to claim 6 wherein evaluating different combinations further comprises:
ordering the schedules that were determined while the capacity constraints are relaxed based upon the collective value of the leg replicants comprising the respective schedules; and
sequentially reevaluating each schedule in order while taking into account the capacity constraints.

8. A method of swapping legs between itineraries comprising:
identifying swap opportunities to swap legs between respective pairs of itineraries;
estimating a benefit of each swap opportunity; and
evaluating, for each swap opportunity that is determined to be beneficial, different combinations of leg replicants for the legs that have been swapped between the respective pair of itineraries in order to construct schedules for the respective pair of itineraries.

9. A method according to claim 8 wherein identifying swap opportunities comprises identifying a swap opportunity between a respective pair of itineraries with each itinerary having a first scheduled flight leg and a subsequent scheduled flight leg, wherein identifying a swap opportunity comprises identifying a pair of itineraries in which: (i) the subsequent scheduled flight leg of one itinerary have a propagated delay, (ii) the first scheduled flight legs of both itineraries has a common destination airport, and (iii) a difference between scheduled departure times of the subsequent scheduled flight legs of the pair of itineraries is no greater than a predefined time.

10. A method according to claim 8 wherein identifying swap opportunities comprises identifying swap opportunities between pairs of itineraries scheduled to be flown by compatible aircraft.

11. A method according to claim 10 wherein identifying swap opportunities between pairs of itineraries scheduled to be flown by compatible aircraft comprises identifying aircraft to be compatible if the aircraft are one of the same type or operationally equivalent.

12. A method according to claim 8 wherein estimating the benefit of each swap opportunity comprises determining a value of each itinerary to be a sum of a value of each leg included in the itinerary, and wherein the method further comprises determining that a swap opportunity is beneficial if the collective value of the pair of itineraries associated with the swap opportunity exceeds the collective value of the itineraries prior to any swap of legs therebetween.

13. A method according to claim 8 further comprising:
determining a value for each itinerary to be a sum of a value of each leg included in the itinerary following evaluation of different combinations of leg replicants; and
accepting the schedules constructed for the pair of itineraries if the collective value of the pair of itineraries exceeds the collective value of the itineraries prior to any swap of legs therebetween.

14. A method of determining an alternative schedule comprising:
constructing a network for each pool of equipment with each node of the network representing an airport at a predefined period of time and each arc representing a leg replicant for a respective flight leg, wherein each pool of equipment comprises leg replicants for the flight legs scheduled to be flown by a plurality of compatible aircraft; and
determining a maximum value path through the network for each of the plurality of compatible aircraft.

15. A method according to claim 14 wherein constructing the network comprises constructing the network such that each arc entering a node represents a leg replicant that has an availability time prior to a departure time of each arc departing the node.

16. A method according to claim 14 further comprising ordering the aircraft and thereafter determining the maximum value path through the network for each aircraft in order.

17. A method according to claim 14 wherein determining the maximum value path through the network comprises eliminating any arcs representative of a leg replicant that requires more of a system resource than is available.

18. A method according to claim 14 wherein determining the maximum value path through the network comprises eliminating any arcs representative of a leg replicant of a flight leg having another leg replicant that has already been included in the maximum value path constructed for another aircraft.

19. A system of determining an alternative schedule comprising:
a processing element for identifying a plurality of leg replicants for at least some legs of a plurality of itineraries, and for evaluating different combinations of the leg replicants for the respective legs of the plurality of itineraries in order to construct schedules for the plurality of itineraries, wherein said processing element initially relaxes at least some capacity constraints while evaluating different combinations of the leg replicants.

20. A system according to claim 19 wherein said processing element utilizes Lagrangian relaxation to initially relax at least some of the capacity constraints and to subsequently reevaluate at least some of the different combinations while subject to the capacity constraints.

21. A system according to claim 20 wherein said processing element also assigns a value to each leg replicant.

22. A system according to claim 21 wherein said processing element assigns the value based upon at least one of distance of the respective leg, seating capacity and an objective function relating value to arrival delay.

23. A system according to claim 21 wherein said processing element evaluates different combinations of the leg replicants by identifying the schedules for the plurality of itineraries that are comprised of combinations of the leg replicants that have the largest collective value.

24. A system according to claim 23 wherein said processing element separately determines the schedule for each itinerary that is comprised of leg replicants having the largest collective value while at least some of the capacity constraints are relaxed.

25. A system according to claim 24 wherein said processing element evaluates different combinations by ordering the schedules that were determined while the capacity constraints are relaxed based upon the collective value of the leg replicants comprising the respective schedules, and then sequentially reevaluating each schedule in order while taking into account the capacity constraints.

26. A system of swapping legs between itineraries comprising:
a processing element for identifying swap opportunities to swap legs between respective pairs of itineraries, estimating a benefit of each swap opportunity, and evaluating, for each swap opportunity that is determined to be beneficial, different combinations of leg replicants for the legs that have been swapped between the respective pair of itineraries in order to construct schedules for the respective pair of itineraries.

27. A system according to claim 26 wherein said processing element identifies a swap opportunity between a respective pair of itineraries with each itinerary having a first scheduled flight leg and a subsequent scheduled flight leg, and the pair of itineraries being such that: (i) the subsequent scheduled flight leg of one itinerary has a propagated delay, (ii) the first scheduled flight legs of both itineraries have a common destination airport, and (iii) a difference between scheduled departure times of the subsequent scheduled flight legs of the pair of itineraries is no greater than a predefined time.

28. A system according to claim 26 wherein said processing element estimates the benefit of each swap opportunity by determining a value of each itinerary to be a sum of a value of each leg included in the itinerary, and wherein said processing element also determines that a swap opportunity is beneficial if the collective value of the pair of itineraries associated with the swap opportunity exceeds the collective value of the itineraries prior to any swap of legs therebetween.

29. A system according to claim 26 wherein said processing element determines a value for each itinerary to be a sum of a value of each leg included in the itinerary following evaluation of different combinations of leg replicants, and accepts the schedules constructed for the pair of itineraries if the collective value of the pair of itineraries exceeds the collective value of the itineraries prior to any swap of legs therebetween.

30. A system of determining an alternative schedule comprising:
a processing element for constructing a network for each pool of equipment with each node of the network representing an airport at a predefined period of time and each arc representing a leg replicant for a respective flight leg, wherein each pool of equipment comprises leg replicants for the flight legs scheduled to be flown by a plurality of compatible aircraft; and wherein said processing element is also capable of determining a maximum value path through the network for each of the plurality of compatible aircraft.

31. A system according to claim 30 wherein said processing element orders the aircraft and thereafter determines the maximum value path through the network for each aircraft in order.

32. A system according to claim 30 wherein said processing element determines the maximum value path through the network by eliminating any arcs representative of a leg replicant that requires more of a system resource than is available.

33. A system according to claim 30 wherein said processing element determines the maximum value path through the network by eliminating any arcs representative of a leg replicant of a flight leg having another leg replicant that has already been included in the maximum value path constructed for another aircraft.

34. A computer program product for determining an alternative schedule, the computer program product comprising a computer-readable storage medium having computer-readable program code embodied in said medium, the computer-readable program code comprising:
a first executable portion adapted to identify a plurality of leg replicants for at least some legs of a plurality of itineraries; and
a second executable portion adapted to evaluate different combinations of the leg replicants for the respective legs of the plurality of itineraries in order to construct schedules for the plurality of itineraries, wherein said second executable portion is adapted to evaluate different combinations of the leg replicants by initially relaxing at least some capacity constraints.

35. A computer program product according to claim 34 wherein said second executable portion is adapted to evaluate different combinations of the leg replicants by utilizing Lagrangian relaxation to initially relax at least some of the capacity constraints and then subsequently reevaluating at least some of the different combinations while subject to the capacity constraints.

36. A computer program product according to claim 35 further comprising a third executable portion adapted to assign a value to each leg replicant.

37. A computer program product according to claim 36 wherein said third executable portion is adapted to assign the value by assigning the value based upon at least one of distance of the respective leg, seating capacity and an objective function relating value to arrival delay.

38. A computer program product according to claim 36 wherein said second executable portion is adapted to evaluate different combinations of the leg replicants by identifying the schedules for the plurality of itineraries that are comprised of combinations of the leg replicants that have the largest collective value.

39. A computer program product according to claim 38 wherein said second executable portion is adapted to identify the schedules by separately determining the schedule for each itinerary that is comprised of leg replicants having the largest collective value while at least some of the capacity constraints are relaxed.

40. A computer program product according to claim 39 wherein said second executable portion is adapted to evaluate different combinations by ordering the schedules that were determined while the capacity constraints are relaxed based upon the collective value of the leg replicants comprising the respective schedules and by sequentially reevaluating each schedule in order while taking into account the capacity constraints.

41. A computer program product for swapping legs between itineraries, the computer program product comprising a computer-readable storage medium having computer-readable program code embodied in said medium, the computer-readable program code comprising:
a first executable portion adapted to identify swap opportunities to swap legs between respective pairs of itineraries;
a second executable portion adapted to estimate a benefit of each swap opportunity; and
a third executable portion adapted to evaluate, for each swap opportunity that is determined to be beneficial, different combinations of leg replicants for the legs that have been swapped between the respective pair of itineraries in order to construct schedules for the respective pair of itineraries.

42. A computer program product according to claim 41 wherein said first executable portion is adapted to identify swap opportunities by identifying a swap opportunity between a respective pair of itineraries with each itinerary having a first scheduled flight leg and a subsequent scheduled flight leg and with the respective pair of itineraries being such that: (i) the subsequent scheduled flight leg of one itinerary has a propagated delay, (ii) the first scheduled flight legs of both itineraries have a common destination airport, and (iii) a difference between scheduled departure times of the subsequent scheduled flight legs of the pair of itineraries is no greater than a predefined time.

43. A computer program product according to claim 41 said second executable portion is adapted to estimate the benefit of each swap opportunity by determining a value of each itinerary to be a sum of a value of each leg included in the itinerary, and wherein the computer program product further comprises a fourth executable portion adapted to determine that a swap opportunity is beneficial if the collective value of the pair of itineraries associated with the swap opportunity exceeds the collective value of the itineraries prior to any swap of legs therebetween.

44. A computer program product according to claim 41 further comprising:
a fourth executable portion adapted to determine a value for each itinerary to be a sum of a value of each leg included in the itinerary following evaluation of different combinations of leg replicants; and
a fifth executable portion adapted to accept the schedules constructed for the pair of itineraries if the collective value of the pair of itineraries exceeds the collective value of the itineraries prior to any swap of legs therebetween.

45. A computer program product for determining an alternative schedule, the computer program product comprising a computer-readable storage medium having computer-readable program code embodied in said medium, the computer-readable program code comprising:
a first executable portion adapted to construct a network for each pool of equipment with each node of the network representing an airport at a predefined period of time and each arc representing a leg replicant for a respective flight leg, wherein each pool of equipment comprises leg replicants for the flight legs scheduled to be flown by a plurality of compatible aircraft; and
a second executable portion adapted to determine a maximum value path through the network for each of the plurality of compatible aircraft.

46. A computer program product according to claim 45 further comprising a third executable portion adapted to order the aircraft such that said second executable portion is adapted to thereafter determine the maximum value path through the network for each aircraft in order.

47. A computer program product according to claim 45 wherein said second executable portion is adapted to determine the maximum value path through the network by eliminating any arcs representative of a leg replicant that requires more of a system resource than is available.

48. A computer program product according to claim 45 wherein said second executable portion is adapted to determine the maximum value path through the network by eliminating any arcs representative of a leg replicant of a flight leg having another leg replicant that has already been included in the maximum value path constructed for another aircraft.
